(19) United States
(12) Patent Application Publication
(10) Pub. No.: US 2007/0000135 A1
(43) Pub. Date: Jan. 4, 2007

(54) Knife structure

(76) Inventor: Chen Fen Chen, Nantou (TW)

Correspondence Address: Chen, Chen Fen, 3620 168th St. apt 3D,, Flushing, NY, 11358, US

(21) Appl. No.: 11/173,649

(22) Filed: Jun. 30, 2005

(51) Int. Cl. B26B 3/00

(52) U.S. Cl. 30/142

(57) ABSTRACT

An improved knife structure includes a main body having a plurality of connecting sections on an edge of the main body; a ceramic knife body having a plurality of connected sections on an edge of the ceramic knife body, and the connected sections are connected by the corresponding connecting sections of the ceramic knife body; a blade section disposed on another edge of the ceramic knife body; and two side panels disposed on both sides of the main body, so that the blade section of the knife is wear-resisting and easy to produce in mass quantity and has the effect of lowering costs.

### FIELD OF THE INVENTION

The present invention relates to an improved knife structure, and more particularly to a knife that is wear-resisting, easy-to-produce in mass quantity, and low-cost.

### BACKGROUND OF THE INVENTION

In general, a traditional knife is made of stainless steel by high-temperature forging. Although a user can use a blade at the edge of the stainless steel knife for cutting, yet the stainless-steel knife is thin and has insufficient hardness, and thus such knife is not long-wearing. Indents may occur or the blade may become slippery and blunt after the knife has been used for a while. As a result, the knife is no longer sharp enough for cutting.

In view of the shortcomings of the stainless steel knives, related manufacturers came up with knives made of ceramics. Although ceramic knives can overcome the shortcomings of stainless-stain knives, the cost of ceramic knives is high, since it is made of ceramic powders by injection or die-casting. Furthermore, the blade of a ceramic knife is not easy to manufacture, particularly for larger size of ceramic knives. If any defect occurs in the manufacturing process, the whole ceramic knife has to be scrapped. Although the blade of a ceramic knife is wear-resisting, the ceramic knife still has the drawback of being too fragile due to its high hardness, and thus the knife will crack or break when falling on the ground or being collided with other objects. Therefore, the aforementioned traditional knives do not meet user requirements for practical uses.

### SUMMARY OF THE INVENTION

It is a primary objective of the present invention to use a ceramic body for a knife in order to make its blade wear-resisting, and to connect a connecting section with a connected section in order to make the mass production easy as well as lower the costs.

To achieve the foregoing objective, an improved knife structure in accordance with the present invention comprises a main body having a plurality of connecting sections on an edge of the main body; a ceramic knife body having a plurality of connected sections on an edge of the ceramic knife body, and the connected sections are connected by the corresponding connecting sections of the main body; a blade section disposed on the other edge of the ceramic knife body; and two side panels disposed on both sides of the main body.

### BRIEF DESCRIPTION OF THE DRAWINGS

FIG. 1 is an exploded view of a knife of the present invention;

FIG. 2 is a schematic view of assembling a knife of the present invention;

FIG. 3 is a perspective view of a knife of the present invention; and

FIG. 4 is a cross-sectional view of Section A-A as depicted in FIG. 3.

### DETAILED DESCRIPTION OF THE PREFERRED EMBODIMENTS

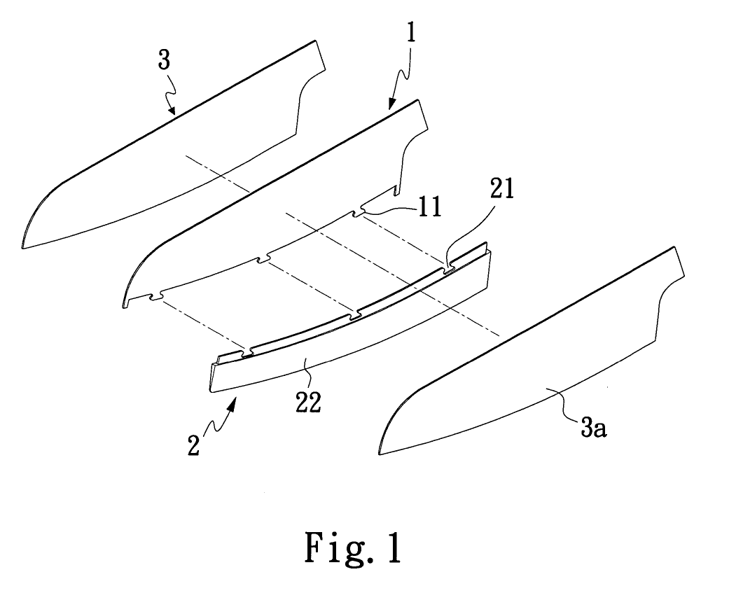

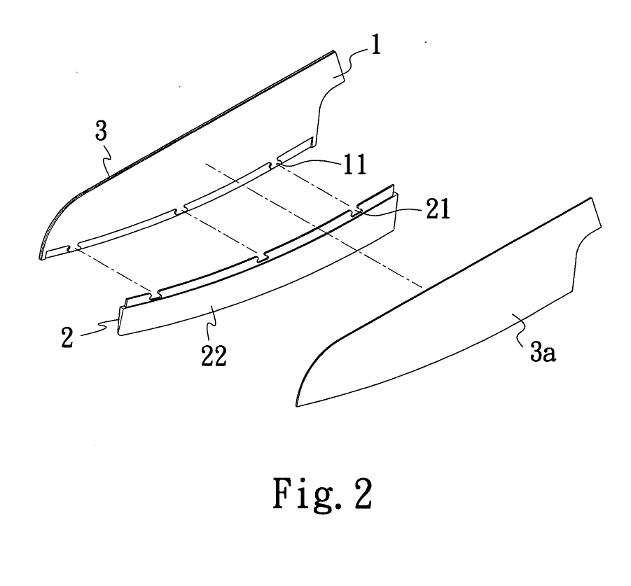

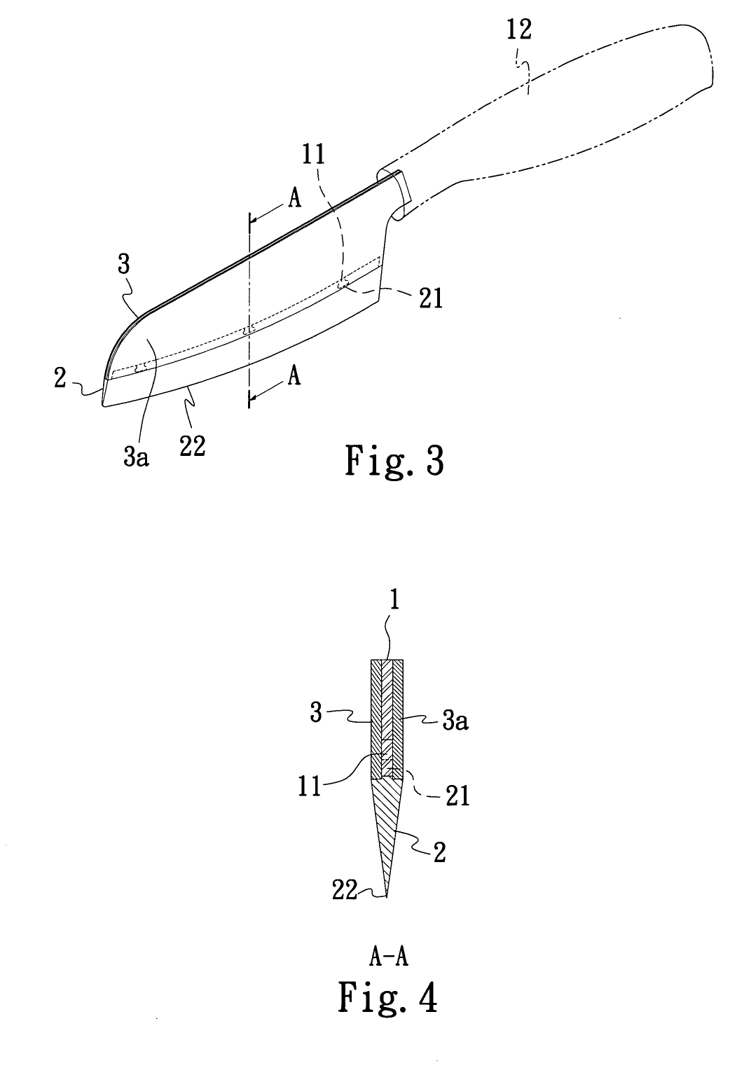

Referring to FIGS. 1 to 4 for the exploded view of the invention, schematic view of assembling the invention, the perspective view of the invention and cross-sectional view of section A-A as depicted in FIG. 3 respectively, an improved knife structure comprises a main body 1, a ceramic knife body 2 and two side panels 3, 3a, that can make the knife wear-resisting, easy to produce in mass quantity and have the effect of lowering costs.

The main body 1 is made of stainless steel or plastic steel, and has a plurality of connecting sections 11 disposed on an edge of the main body 1, and a holding section 12 is disposed at a distal end of the main body 1.

The ceramic knife body 2 has a plurality of connected sections 21 disposed on an edge of the ceramic knife body 2 and coupled to the corresponding connection sections 11 of the main body 1, and the ceramic knife body 2 has a blade section 22 disposed on another edge of the ceramic knife body 2.

The side panels 3, 3a are made of stainless steel or plastic steel and disposed separately on both sides of the main body 1. The two side panels 3, 3a can be coupled with the main body by spot welding or adhesion. With the foregoing components, an improved knife structure is made.

When the knife structure of the invention is assembled, one of the side panels 3 is coupled to a surface of the main body 1 by spot welding or adhesion, and then the connected sections 21 on one edge of the ceramic knife body 22 are engaged and coupled with the corresponding connecting sections 11 of the main body 1 by adhesion, and finally another side panel 3a is coupled with another surface of the main body 1 by spot welding or adhesion. After the two side panels 3, 3a are coupled with the main body 1, the distal ends of the two side panels 3, 3a and the distal ends of the connecting sections 11 of the main body are on the same plane, and thus the main body 1, the connecting sections 11 and connected sections 21 of the ceramic knife body 2 are restricted between the two side panels 3, 3a, so as to complete the assembling of the knife. Users can hold the holding section 12 and use the blade section 22 on another edge of the ceramic knife body 2 for cutting.

In summation of the description above, the improved knife structure of the present invention can effectively overcome the shortcomings of the prior arts. With the ceramic knife body, the blade section is more wear-resisting, and the connection of the connecting sections and connected sections are used to facilitate the mass production and lower the costs. The present invention herein enhances the performance than the conventional structure and further complies with the patent application requirements and is submitted to the Patent and Trademark Office for review and granting of the commensurate patent rights.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An improved knife structure, comprising:
a main body, having a plurality of connecting sections disposed on an edge of said main body;
a ceramic knife body, having a plurality of connected sections disposed on an edge of said ceramic knife body and coupled to said corresponding connection sections of said main body, and said ceramic knife body further including a blade section disposed on another edge of said ceramic knife body; and
two side panels, being disposed separately on both sides of said main body.

2. The improved knife structure of claim 1, wherein said main body includes a holding section disposed at a distal end of said main body.

3. The improved knife structure of claim 1, wherein said main body and two side panels are made of stainless steel.

4. The improved knife structure of claim 1, wherein said main body and two side panels are made of plastic steel.

5. The improved knife structure of claim 1, wherein said two side panels are coupled with said main body by spot welding.

6. The improved knife structure of claim 1, wherein said two side panels are coupled with said main body by adhesion.
